(19) United States
(12) Patent Application Publication
(10) Pub. No.: US 2005/0108353 A1
(43) Pub. Date: May 19, 2005

(54) Image processing device and control method of image processing device

(75) Inventor: Masahito Yamamoto, Tokyo (JP)

Correspondence Address: Canon U.S.A. Inc.;Intellectual Property Department, 15975 Alton Parkway, Irvine, CA, 92618-3731, US

(73) Assignee: Canon Kabushiki Kaisha, Tokyo (JP)

(21) Appl. No.: 10/990,263

(22) Filed: Nov. 16, 2004

(30) Foreign Application Priority Data
Nov. 18, 2003 (JP) 2003-388412

(51) Int. Cl. G06F 15/00; G06F 15/16

(52) U.S. Cl. 709/208; 358/1.15; 709/246

(57) ABSTRACT

An image processing device communicable with a server on a LAN includes a scanner that inputs image information, a user interface that inputs a URL for specifying an information resource on the server, a web browser module which receives, from the server, an HTML document for sending image data to the information resource, an operating portion that displays a display screen for starting data transmission to the information resource based on the HTML document, and a control unit that starts input of the image data to the scanner and starts the transmission of the image data in accordance with an operation of the display screen.

### BACKGROUND OF THE INVENTION

1. Field of the Invention

The present invention relates to an image processing device and a control method of the image processing device.

2. Description of the Related Art

A web page creator (web server) requests the input of information from a user (client) who browses a web page using a form element on HTML (HyperText Markup Language). The HTML form can be used for various applications, which need user's input, and the HTML form generates a user interface between the web page creator and the user. Thus, web applications are provided that operate on the web server side and are operated from a client's web browser.

The web browser of the user, as the client, requests an HTML resource from the web server and thus obtains the resource from the web server. Then, a user interface based on the HTML is displayed on the web browser of the client. Here, information is input by the user to the form displayed on the web browser and then the input information is sent to the server from the client. It is possible to obtain, from the server, content that reflects information returned in response to the input information, namely, the execution result of the application. In many cases, the sent content is a user interface of the web application structured by the HTML form. The repetition thereof realizes a so-called distributed application on which the web application operating on the remote server is operated by the user interface sent on the web browser of the client.

As mentioned above, many systems realize the use of the HTML which can be interactive using the form for information communication as a user interface description language that can be remotely transferred.

RFC1867 discloses a “method for uploading a file based on the HTML form”. The method extends the interactivity of information communication using the HTML form, and the file stored in the client's platform is uploaded as an input to the server of the distributed application. According to the method, a general web browser which is put into practical use and a large volume of web content are loaded.

According to another method (refer to Japanese Patent Laid-Open No. 2001-94960), a content file such as an HTML document is uploaded to the web server.

FIG. 16 shows a screen example of the form displayed on the general web browser according to RFC1867 as a conventional art. The screen in the form is generated based on an HTML document which will be described later with reference to FIG. 10, and is displayed on a content display area 2001 of the web browser. On the screen, indication 2002 corresponds to elements h1 and o1 on the fourth to eighth lines in FIG. 10, and an area surrounded by a dotted line of indication 2003 corresponds to a file-type input element on the eleventh line in FIG. 10. Indication 2004 corresponds to a submit-type input element on the twelfth line shown in FIG. 10.

In the area of the indication 2003, the web content is loaded according to the general method on the conventional web browser. The method of implementation is disclosed in RFC1867. In the area of the indication 2003, indication 2005 corresponds to a file-name input field, whereupon the list of file paths (file names) in a file system of the uploaded file is input depending on types. Indication 2006 corresponds to a file select button. When the button 2006 is pressed down, the status enters a file select mode matching a platform on which the web browser is operated. On the web browser operated on the general computer, a file select dialog is opened and the file to be uploaded from the files stored in the file system is selected.

In accordance with the development and spread of Internet technology, various distributed application services are provided in view of the widespread distribution of client web browsers. In particular, in the IT (information technology) field, an application service provider (ASP) has started to provide a distributed application service as a provider dedicated to providing distributed applications on the web. The ASP providing service includes the operation for the information providing, information creation, information search, information storage, certification, distribution, printing, publishing, management, translation, and commission. Further, the ASP providing service includes the procedure for public offices and various types of e-commerce.

In the field of embedded systems, the device has a web server function in addition to the original function, and a remote user interface has been put into the market to provide the user interface of the device for a remote web browser. Further, it is well-known that the device has a web client function in addition to the original function, various content is downloaded for browsing from the remote web server, and the content is applicable to the device functions.

Japanese Patent Laid-Open No. 2002-158953 discloses an image processing device including web browsing means which browses the homepage of the web server connected to image pick-up list input means and which downloads the image pick-up list on the homepage.

Further, Japanese Patent Laid-Open No. 2002-170110 discloses a system for sending image data from a server to a terminal, such as a mobile phone, in which the image processing is shared best between the server and the mobile phone including the web browser. Another system is disclosed to upload the image.

Furthermore, Japanese Patent Laid-Open No. 2002-171381 discloses an electronic-manuscript receiving system comprising the web server and the web client.

In addition, Japanese Patent Laid-Open No. 2002-183743 discloses an information system for generating a work comprising image information, in which an uploaded page for the image embedded in a scenario is sent to the client.

In the work flow of the distributed application provided by the ASP, the possibility of distributed application is extended by uploading image data that is not digitized. For example, in the work flow of the e-commerce or procedure for the public offices, it is expected to request an input of a public document, such as a certification or order sheet, on which the personal seal or signature is described at the proper timing of the procedure.

In the case of the system structured by combining the web client and image input means corresponding to the general web application, an image data file input by an image processing device is stored in memory, for example, to a hard disk, and then the file is uploaded, namely, the two operations are performed. That is, the operation becomes complicated because two steps of an image input step and an uploading step are required. Further, in the case of using a scanner for reading the image of the original as the image input means, there is a danger that the costs are increased because memory capacity is necessary for temporarily storing the image data corresponding to the entire number of pages in storage.

Further, it is possible to structure a system for inputting an image and uploading image data by one time based on the web technology by adding the specific arrangement between the server and the client. However, in this system, the service generality on the ASP side deteriorates because of the specific arrangement between the server and the client.

### SUMMARY OF THE INVENTION

The present invention is devised in consideration of the above-mentioned problems, and provides an improved image processing device and a control method of the image processing device.

Further, the present invention provides an image processing device and a control method of the image processing device, for enabling the one-time operation for inputting image information and for starting transmission of data corresponding to the image information to a server.

In addition, the present invention provides an image processing device and a control method of the image processing device, in which a display screen is displayed to start the operation of an information resource based on document information received from a server on a network. The input operation of the image information is started in accordance with the operation on the display screen, and the transmission of data on the image information to the server is started.

According to an aspect of the present invention, an image processing device communicable with a server on a network includes: an image input unit configured to input image information; a receiving unit configured to receive form information for sending data in accordance with the image information to an information resource on the server; a sending unit configured to send data to the server; a display unit configured to display a display screen for starting data transmission to the information resource by the sending unit based on the form information; and a control unit configured to start input of the image information to the image input unit and to start transmission of data corresponding to the image information to the sending unit in accordance with an operation of the display screen.

According to another aspect of the present invention, a control method of an image processing device communicable with a server on a network includes: receiving, from the server, form information for sending data in accordance with image information to an information resource on the server; displaying a display screen for starting data transmission to the information resource based on the form information; starting input of the image information in accordance with an operation of the display screen; and starting transmission of data corresponding to the image information, to the server, in accordance with an operation of the display screen.

Other features and advantages of the present invention will become be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing the entire structure of a system including an image processing device according to the first embodiment of the present invention.

FIG. 2 is a block diagram showing the software structure of the image processing device shown in FIG. 1.

FIG. 3 is a block diagram showing the detailed structure of the image processing device shown in FIG. 1.

FIG. 4 is an appearance view showing the image processing device shown in FIG. 1.

FIG. 5 is a diagram showing the structural appearance of an operating portion shown in FIG. 1.

FIG. 6 is a block diagram showing the detailed structure of the operating portion shown in FIG. 1.

FIG. 7 is a block diagram showing the software structure of a web browser module.

FIG. 8 is a diagram showing the screen structure of a web browser displayed on an LCD (Liquid Crystal Display) by a UI (user interface).

FIG. 9 is a sequence diagram showing the flow of the processing of the request and response of a HyperText Transfer Protocol (HTTP) according to the first embodiment.

FIG. 10 is a diagram showing an example of an HTML document which includes a form and in which a POST method is designated as a method of sending the form.

FIG. 11 is a diagram showing a screen displayed in a content display area of the web browser based on the HTML document shown in FIG. 10.

FIG. 12 is a flowchart showing the sequence of the layout processing of objects corresponding to a file-type input element which is executed by web browsers of image processing devices.

FIG. 13 is a flowchart showing the sequence of the processing for submitting the form which is executed by the web browsers of the image processing devices.

FIG. 14 is a diagram showing an example of a dialog window displayed for the operation setting processing of an image input function by the web browser.

FIG. 15 is a flowchart showing the sequence of the processing for submitting the form which is executed by the web browser according to a second embodiment of the present invention.

FIG. 16 is a diagram showing a screen example of the form displayed on a general web browser according to RFC1867 as a conventional art.

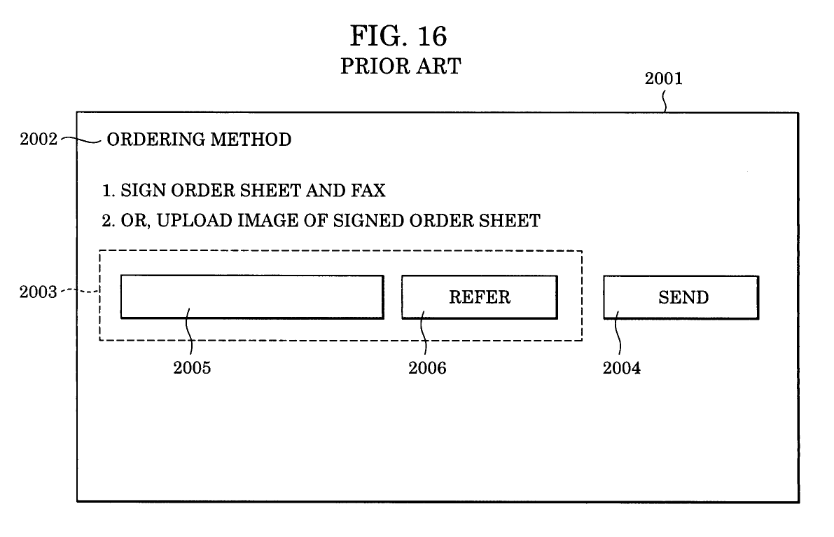

### DESCRIPTION OF THE EMBODIMENTS

The present invention will now be described in detail with reference to the drawings showing preferred embodiments thereof. In the drawings, elements and parts which are identical throughout the views are designated by identical reference numerals, and duplicate description thereof is omitted.

### First Embodiment

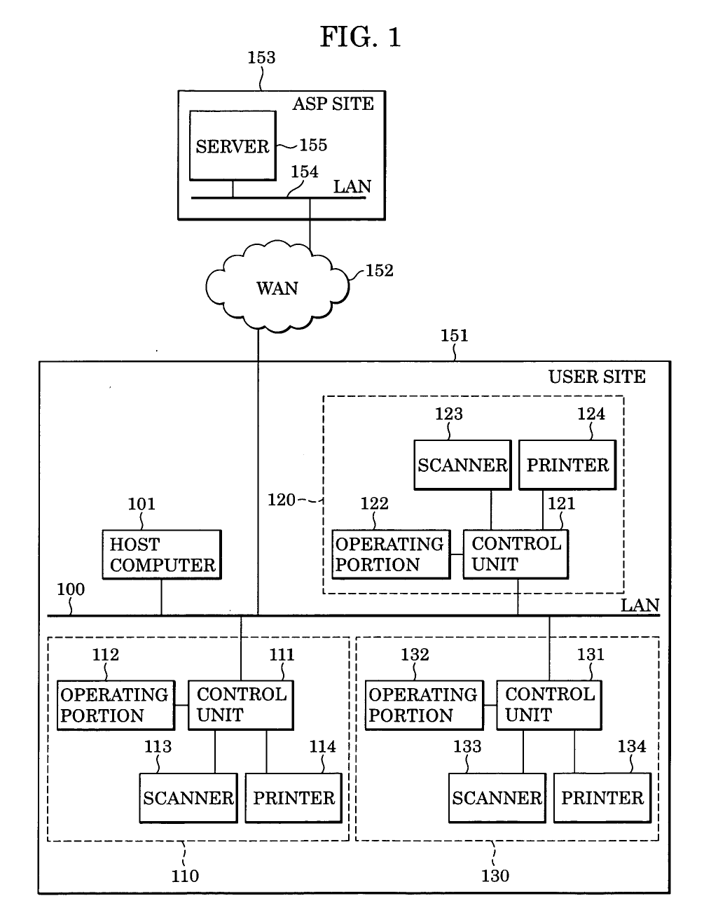

FIG. 1 is a block diagram showing the entire structure of a system including an image processing device according to the first embodiment of the present invention.

Referring to FIG. 1, the system includes: an application service provider site (hereinafter, referred to as an ASP site) 153; a wide area network (WAN) 152; and a user site 151. Here, the wide area network 152 is the Internet. The wide area network 152 may be a virtual private network (VPN) on the Internet or a dedicated private network.

The ASP site 153 provides a predetermined service to the user site 151 via the wide area network 152. The service provided by the ASP site 153 includes the operation for the information providing, information creation, information search, information storage, certification, distribution, printing, publishing, management, translation, and commission. Further, the ASP providing service includes the procedure for public offices and various types of e-commerce. The ASP site 153 includes a LAN (Local Area Network) 154 and a server 155. The LAN 154 is a network in the ASP site 153, and connects network devices in the ASP site 153. The LAN 154 is connected to the wide area network 152 via a router.

On the server 155, the software is operated for realizing the service provided by the ASP. A software module includes:
1) an HTTP server that sends the content such as HTML in response to the request of the HTTP protocol from the client;
2) an application loaded as a CGI (Common Gateway Interface) program or Servlet, that is executed by the HTTP server in response to the HTTP request, executes predetermined processing, and responds to the HTTP which dynamically changes; and
3) business logic of an e-commerce program or the like and database management system at the back end, that are used for executing the predetermined processing by the CGI program or servlet.

The user site 151 includes: a plurality of network devices including a host computer 101, image processing devices 110, 120, and 130, and a LAN 100 for connecting the network devices. The LAN 100 of the user site 151 is connected to the wide area network 152 via a router. Here, the router includes a firewall function. That is, the router performs packet filtering so as to protect the user site 151 against attack from an external network. The network address translation or network port translation might be executed on the router depending on the address management.

The function of the router is limited in the communication between the user site 151 and the external network. That is, in many cases, only communication using certain specific protocols is possible. For example, the HTTP connection established to the outside from the inside is generally permitted, advantageously providing the application service based on the general web technology.

The image processing device 110 is a multi-function product (MFP) device that inputs/outputs an image and executes various image processing. The image processing device 110 includes: a scanner 113 as an image input device; a printer 114 as an image output device; a control unit 111; and an operating portion 112 as a user interface. The scanner 113, the printer 114, and the operating portion 112 are connected to the control unit 111, and are controlled by a command from the control unit 111. The control unit 111 is connected to the LAN 100.

The image processing devices 120 and 130 have the same device structure as that of the image processing device 110, and are connected to the LAN 100. The image processing device 120 includes: a scanner 123; a printer 124; a control unit 121 that controls the scanner 123, the printer 124, and the operating portion 122. The image processing device 130 includes: a scanner 133; a printer 134; an operating portion 132; a control unit 131 that controls the scanner 133, the printer 134, and the operating portion 132.

The host computer 101 is connected to the LAN 100. The host computer 101 has a web browser, which will be described later, for displaying the statuses of the image processing devices 110, 120, and 130 based on the HTML file received from the image processing devices 110, 120, and 130. The host computer 101 receives the service by the HTTP connection to the server 155.

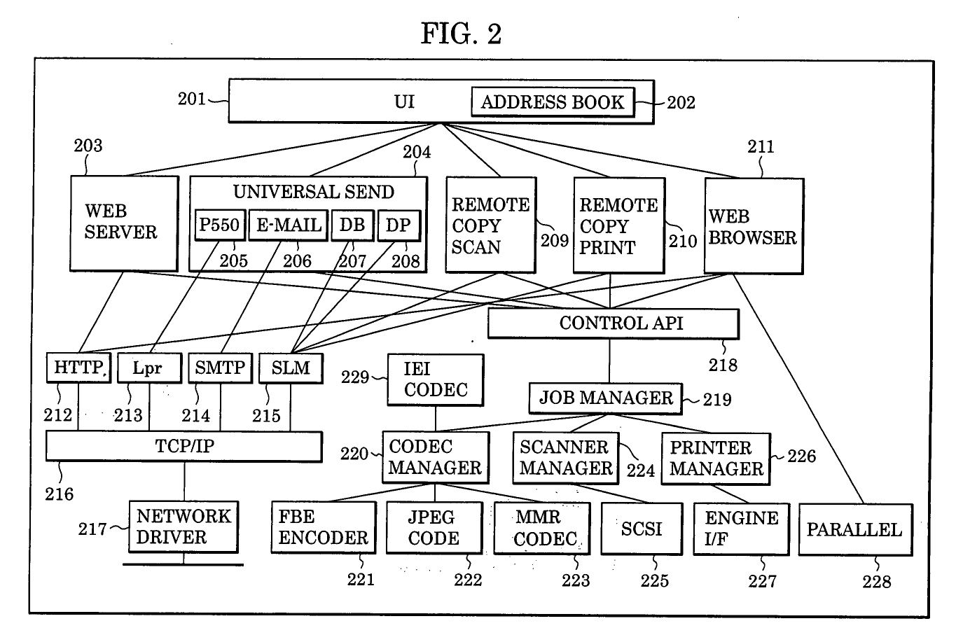

Next, a description is given of the software structure of the image processing device 110 with reference to FIG. 2. FIG. 2 is a block diagram showing the software structure of the image processing device 110 shown in FIG. 1. Since the image processing devices 110, 120, and 130 have the same the software structure, only the software structure of the image processing device 110 will be described.

The image processing device 110 includes a user interface (UI) module 201. The UI module 201 mediates between the device and the user operation when the operator performs various operations and settings of the image processing device 110. The UI module 201 transfers input information to various modules, which will be described later, in accordance with the operator's operation, and requests the processing or sets the data.

The image processing device 110 includes an address book module 202 as a database module which manages the sending destination and the communication destination of the data. The data managed by the address book module 202 is added, deleted, and obtained by the operation from the UI module 201. The address book module 202 provides the sending destination information and the communication destination information for the modules, which will be described later, by the operation of the operator.

The image processing device 110 also includes a web server module 203 which sends, to the web client, a notification as management information of the image processing device 110 in response to the request from the web client (e.g., host computer 101). The management information is obtained via a universal send module 204, a remote copy scan module 209, a remote copy print module 210, and a control API module 218, which will be described later. Further, the management information is notified to the web client via an HTTP module 212, a TCP/IP (transmission control protocol/Internet protocol) module 216, and a network driver 217 to the web client, which will be described later.

In addition, the image processing device 110 includes a web browser module 211 which reads and displays information on various web sites (homepages) on the Intranet or Internet. The detailed structure of the web browser module 211 will be described later.

The universal send module 204 distributes data instructed by the operator via the UI module 201 to the communication (output) destination which is similarly instructed. The universal send module 204 operates the device via the control API module 218 and generates the data upon instructing the generation of distribution data by the operator using the scanner function of the device. The universal send module 204 includes: a P550 module 205 which is executed upon designating the printer as the output destination; an E-mail module 206 which is executed upon designating the E-mail address as the communication destination; a DB module 207 which is executed upon designating the database as the output destination; and a DP module 208 which is executed upon designating the image processing device similar to the device as the output destination.

The remote copy scan module 209 reads the image information by using the scanner function of the image processing device 110, and outputs the read image information to another image processing device connected via the network, thus performing the copy function realized by the single image processing device by using another image processing device.

The remote copy print module 210 outputs the image information obtained by another image processing device connected via the network by using the printer function of the image processing device 110, thus performing the copy function realized by the single image processing device by using another image processing device.

The HTTP module 212 is used in the HTTP communication of the image processing device 110, and provides a communication function for the web browser module 211 or the web server module 203 by using a TCP/IP communication module 216, which will be described later. The HTTP module 212 provides the communication function using the protocol corresponding to the security, depending on the various protocols used by the web such as the HTTP.

The image processing device 110 further comprises an Lpr module 213 which provides the communication function for the P550 module 205 in the universal send module 204 by using the TCP/IP communication module 216, which will be described later.

The image processing device 110 further includes an SMTP (simple mail transfer protocol) module 214 which provides the communication function for the E-mail module 206 in the universal send module 204 by using the TCP/IP communication module 216, which will be described later.

The image processing device 110 further includes an SLM (salutation manager) module 215 which provides the communication function, by using the TCP/IP communication module 216 which will be described later, for the network driver 217 and the control API module 218 in the universal send module 204, the remote copy scan module 209, and the remote copy print module 210.

The TCP/IP communication module 216 provides a network communication function for the above-mentioned various modules, by using the network driver 217. The network driver 217 controls a part which is physically connected to the network.

The control API 218 provides an interface to the down module such as a job manager module 219 to the up module such as the universal send module 204. Thus, the dependent relationship between the up and down modules is reduced and the diversion property of modules is improved.

The job manager module 219 interprets various processing instructed via the control API 218 from the various modules, and provides instruction modules including modules 220, 224, and 226. The job manager module 219 systematically manages the processing of the hardware which is executed in the image processing device 110.

A codec manager module 220 manages and controls the compression and decompression of data in the processing instructed by the job manager module 219.

The image processing device 110 further includes an FBE encoder module 221 which compresses, in an FBE format, data read by the scanning processing executed by the job manager module 219 or the scan manager module 224, which will be described later.

The image processing device 110 further comprises a JPEG CODEC (compression/decompression) module 222 which performs the JPEG (Joint Photographic Experts Group) compression of the read data and the JPEG development of the printing data in the printing processing executed by the print manager module 226 or the scanning processing executed by the job manager module 219 or scan manager module 224.

The image processing device 110 further includes an MMR CODEC module 223 which performs the MMR (Modified Modified READ) decompression of the printing data and the MMR compression of the read data in the printing processing executed by the print manager module 226 or the scanning processing executed by the job manager module 219 or scan manager module 224.

The image processing device 110 further includes an information embedded image CODEC (IEI CODEC) module 229 which embeds the image to the printing image data and decodes the information embedded to the read image data in the printing processing executed by the print manager module 226 or in the scanning processing executed by the job manager module 219 or scan manager module 224. The information is embedded in the image data by using code technology such as a barcode or digital watermark. The IEI CODEC module 229 supports, as a decoding technology, the character recognition which recognizes the character in the image of the image data by the image separation and the OCR technology and which further converts the character into text data. Further, the conversion to the image data from the text using a raster image processor and the overlying operation of the converted image data and the original image data are supported as a coding technology (information embedding technology).

The scan manager module 224 manages and controls the scanning processing which is instructed by the job manager module 219. The communication between the scan manager module 224 and the scanner 113 internally connected to the image processing device 110 is performed via an SCSI driver 225.

The print manager module 226 manages and controls the printing processing instructed by the job manager module 219. The interface between the print manager module 226 and the printer 114 is provided by an engine interface module 227.

The image processing device 110 further includes a parallel port driver 228 which provides an interface upon outputting data to an output device (not shown) via a parallel port by the web browser module 211.

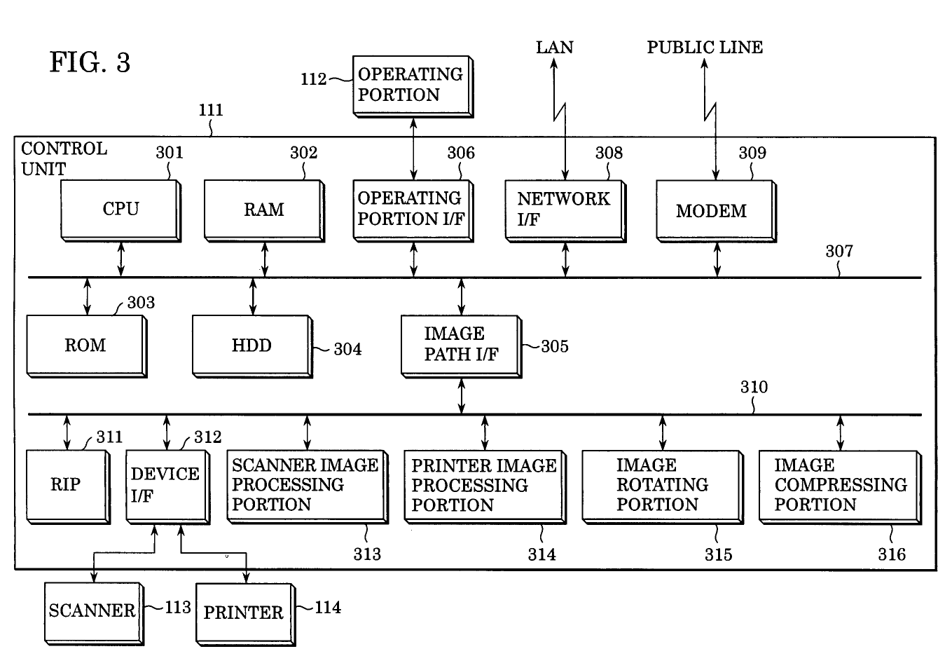

Next, a description is given of the structure of the image processing device 110 with reference to FIG. 3. FIG. 3 is a block diagram showing the detailed structure of the image processing device 110 shown in FIG. 1. The image processing devices 110, 120, and 130 have the same structure and therefore only the structure of the image processing device 110 is described.

Referring to FIG. 3, the image processing device 110 includes the control unit 111, which entirely controls the device. The control unit 111 connects the scanner 113 as an image input device and the printer 114 as an image output device, controls the scanner 113 and the printer 114, and is connected to the LAN or public line, inputting and outputting image information and device information via the LAN or public line.

The control unit 111 includes a central processing unit (CPU) 307 connected to a system bus 307. The CPU 301 is connected to a random-access memory (RAM) 302, a read-only memory (ROM) 303, a hard disk drive (HDD) 304, an image bus interface (I/F) 305, an operating portion I/F 306, a network I/F 308, and a modem 309.

The RAM 302 is a memory which provides a working area of the CPU 301, and is used as an image memory for temporarily storing the image data. The ROM 303 is a booting ROM, and stores a booting program of the system. The HDD 304 stores therein system software and image data.

The operating portion I/F 306 is an interface for inputting and outputting data to the operating portion 112, outputs the image data displayed on the operating portion 112, and transfers the information input by the user via the operating portion 112 to the CPU 301.

The network I/F 308 is connected to the LAN and inputs and outputs the information to the LAN. The modem 309 is connected to the public line and inputs and outputs the information to the public line.

The image bus I/F 305 is a bus bridge which connects the system bus 307 to an image bus 310 for transferring the image data at high speed and converting the data structure.

Connected to the image bus 310 are a raster image processor (RIP) 311, a device I/F 312, a scanner image processing portion 313, a printer image processing portion 314, an image rotating portion 315, and an image compressing portion 316.

The RIP 311 develops PDL (page description language) code received from the LAN to a bitmap image. The device I/F 312 connects the scanner 113, the printer 114, and the control unit 111, thus converting a synchronous system/asynchronous system of the image data. The scanner image processing portion 313 corrects, processes, and edits the input image data. The printer image processing portion 314 corrects the printer and converts the resolution of the input image data. The image rotating portion 315 rotates the image data. The image compressing portion 316 performs the JPEG compression and decompression of multi-value image data, and performs the JBIG (Joint Bi-Level Image Experts Group), MMR, and MH (Modified Huffman) compression and decompression of binary image data.

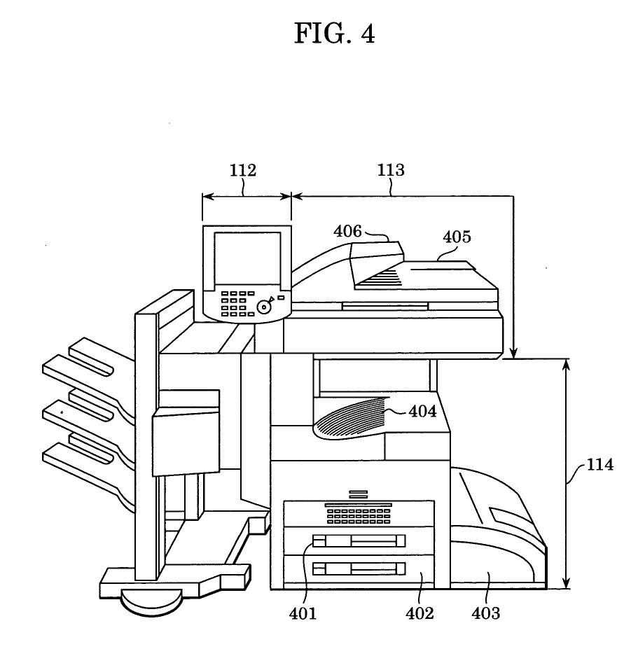

A description is given of the appearance of the image processing device with the above-mentioned structure with reference to FIG. 4. FIG. 4 is an appearance view showing the image processing device 110 shown in FIG. 1. The image processing devices 110, 120, and 130 have the same structural appearance and therefore only the structural appearance of the image processing device 110 will be described.

In the image processing device 110, the scanner 113 illuminates the image on the sheet as the original, and scans a CCD (charge-coupled device) line sensor (not shown), to generate the raster image data. A user sets an original sheet on a tray 406 of an original feeder 405, and instructs the starting operation of the reading in the operating portion 112. Then, the CPU 301 of the controller unit 111 issues an instruction to the scanner 113. The original feeder 405 feeds the original sheets one by one and the scanner 113 reads the original image fed from the original feeder 405.

The printer 114 prints the raster image data on the sheet. The printing method is an electronic photographing method using a photosensitive belt or a photosensitive drum. The printing method may be another method such as an ink-jet method which discharges the ink from a fine nozzle array and directly prints the image on the sheet. The printing operation of the printer 114 is started by the instruction from the CPU 301. The printer 114 has a plurality of sheet-feed-stages so as to select the different sheet size or different sheet direction, and has sheet cassettes 401, 402, and 403 corresponding thereto. The printer 114 further has a sheet discharge tray 404 and the sheet on which the data has been printed is discharged to the sheet discharge tray 404.

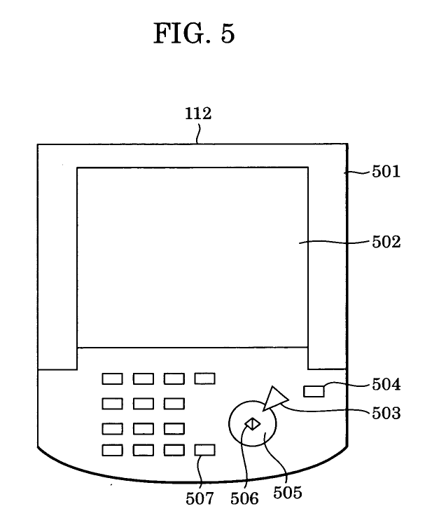

Next, a description is given of the structure of the operating portion 112 shown in FIG. 1 with reference to FIG. 5. FIG. 5 is a diagram showing the structural appearance of the operating portion 112 shown in FIG. 1.

Referring to FIG. 5, the operating portion 112 includes an LCD display portion 501 on which a touch panel sheet 502 is displayed on the LCD. The LCD display portion 501 displays an operating screen and a soft key of the system. The displayed key is pressed and then positional information indicating the pressed position is transmitted to the CPU 301.

The operating portion 112 includes hard keys such as a start key 505, a stop key 503, an ID key 507, and a reset key 504. The start key 505 is a key for instructing the start of the reading operation of the original image, and LED display portions 506 having two colors of green and red are arranged in the center of the start key 505. The two-color LED display portion 506 indicates whether or not the start key 505 is available. The stop key 503 stops the operation which is in progress. The ID key 507 is used for inputting a user ID. The reset key 504 is used for initializing the setting from the operating portion 112.

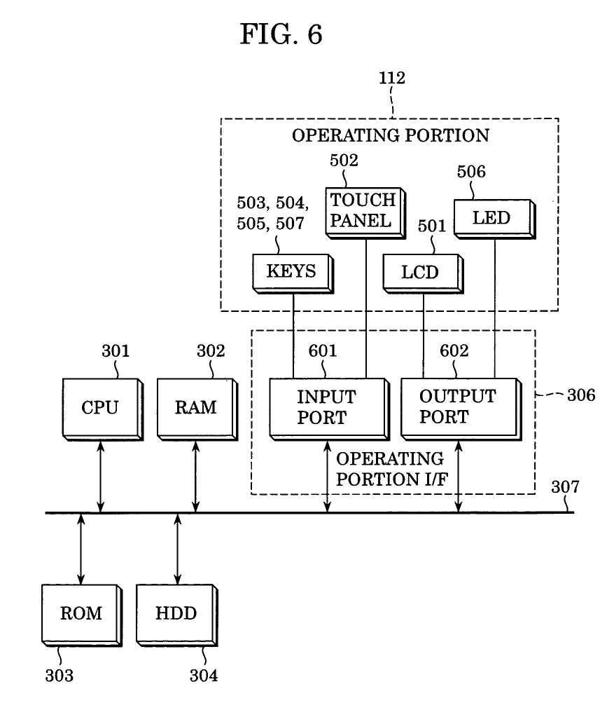

Next, a description is given of the structure of the operating portion 112 with reference to FIG. 6. FIG. 6 is a block diagram showing the detailed structure of the operating portion 112 shown in FIG. 1.

Referring to FIG. 6, the operating portion 112 is connected to the system bus 307 via the operating portion I/F 306. As mentioned above, connected to the system bus 307 are the CPU 301, the RAM 302, the ROM 303, and the HDD 304.

The operating portion I/F 306 includes an input port 601 for controlling the input from the user and an output port 602 for controlling a screen output device. The input port 601 transmits, to the CPU 301, the user inputs from keys including the touch panel 502 and hard keys 503, 504, 505, and 507. The CPU 301 generates display screen data based on content of the user input and the control program, and outputs a display screen on the LCD display portion 501 via the output port 602. The CPU 301 controls the LCD display portion 506 via the output port 602 if necessary.

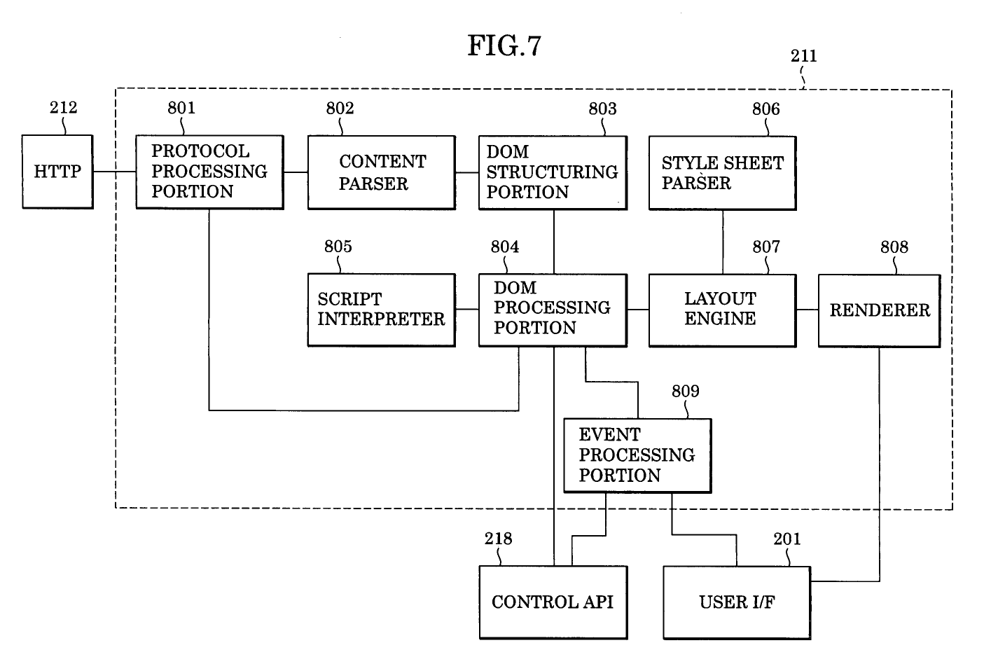

Next, a description is given of the software structure of the web browser module 211 with reference to FIG. 7. FIG. 7 is a block diagram showing the software structure of the web browser module 211.

Referring to FIG. 7, the web browser module 211 includes a protocol processing portion 801, a content parser 802, a DOM (document object model) structuring portion 803, a DOM processing portion 804, a layout engine 807, a style sheet parser 806, a renderer 808, a script interpreter 805, and an event processing portion 809.

The protocol processing portion 801 establishes the connection to another network node via the HTTP module 212 and communicates data. In the communication, the HTTP request is issued to the resource described by the URL (uniform resource locator), and the response is obtained. In this processing, the communication data according to various encoding formats are encoded and decoded.

The content parser 802 receives the content data expressed by the expressing format such as HTML, XML (extensible Markup Language), and XHTML (extensible HyperText Markup Language), and analyzes the words and sentences to generate an analyzing tree.

The DOM structuring portion 803 receives the analyzing tree from the content parser 802, and structures a document object model corresponding to the structure of the content data. The conventional HTML permits various omissions in terms of grammar and the variation is wide. Further, the well-formed content that is actually operated is not valid in many cases. Then, the DOM structuring portion 803 estimates the correct logic structure of the content data that is not valid in terms of grammar, and structures the valid DOM.

The DOM processing portion 804 holds and manages the DOM structured by the DOM structuring portion 803 as a tree structure for expressing the nested structure of objects. Various processing of the web browser is expressed with the DOM as a center.

The layout engine 807 recursively determines the expression (presentation) on the object display in accordance with the tree structure of the objects held by the DOM processing portion 804, and thus obtains the layout of the entire documents. The expression on the object display is clearly designated in the style sheet format, such as a cascading style sheet (CSS), by the description embedded in the document or the description in another file linked from the description. Further, the layout engine 807 reflects the analysis result of the style sheet by using the style sheet parser 806, and determines the document layout.

The style sheet parser 806 analyzes the style sheet related to the content document.

The renderer 808 generates GUI (graphical user interface) data displayed on the LCD 501 in accordance with document layout determined by the layout engine 807. The generated GUI data is displayed on the LCD 501 by the UI (user interface) 201.

The event processing portion 809 receives the event of the operation performed by the user in accordance with the touch panel sheet 502 on the operating portion 112 or the keys, and executes the processing corresponding to the event. The event processing portion 809 further receives a status transition event of the device or job from the control API 218, and executes the processing corresponding to the event. The tree structure of the DOM managed by the DOM processing portion 804 registers therein an event handler corresponding to the events depending on the object class and object instance. The event processing portion 809 determines the object for executing the event processing among the objects managed by the DOM processing portion 804, and distributes the event. The object, to which the event is distributed, executes various processing in accordance with the algorithm of the event handler corresponding to the event. The processing of the event handler includes the update of the DOM held by the DOM processing portion 804, the re-drawing instruction for the layout engine, the instruction for issuing the HTTP request for the protocol processing portion 801, and the control of the image processing device function using the call of the control API 218.

The script interpreter 805 interprets and executes the script such as JavaScript (ECMA Script). The script is embedded in the document or is described in another file linked from the document, thus performing the operation for the DOM. The content provider programs the dynamic action of the provided document.

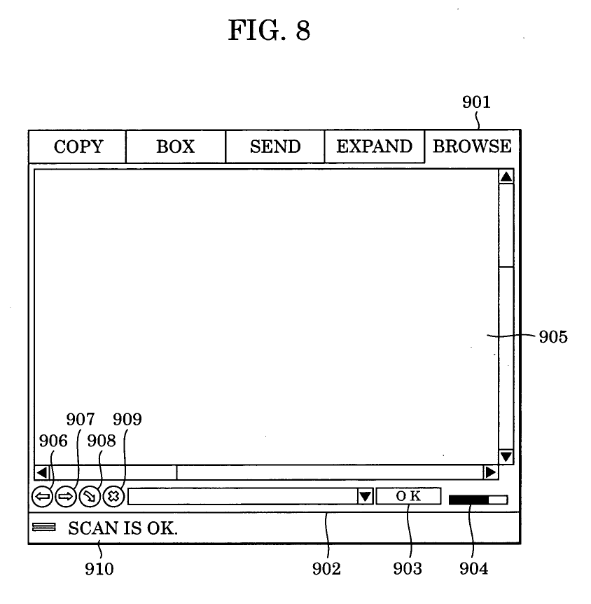

Next, a description is given of the screen structure of the web browser displayed on the LCD 501 by the UI interface 201 with reference to FIG. 8. FIG. 8 is a diagram showing the screen structure of the web browser displayed on the LCD 501 by the interface 201.

Referring to FIG. 8, the screen of the web browser displayed on the LCD 501 by the UI interface 201 displays thereon a tab 901, a URL input field 902, an OK button 903, a progress bar 904, a content display area 905, a return button 906, an advance button 907, a reload button 908, a stop button 909, and a status area 910.

The tab 901 switches the screen between the web browser function and other functions (copy, box, transmission, and extension). The URL input field 902 is a field for inputting the URL of the user's desired resource, the user presses down the field, and then a virtual full keyboard (not shown) is displayed in order for the user to input characters. The user inputs a desired characters string using a soft key like the key top arranged onto the virtual full key-board.

The OK button 903 determines the input URL character string. Upon determining the URL, the web browser module 211 issues the HTTP request for obtaining the resource. The progress bar 904 indicates the progress of the content obtaining processing in response to the HTTP request. The content display area 905 displays the obtained resource. The return button 906 is a soft key for tracing the history of the content display operation and for re-displaying the content displayed before the content that is currently displayed. The advance button 907 is a soft key for returning the display content after the content that is currently displayed upon tracing and displaying the history of the content display. The reload button 908 re-obtains and re-displays the content that is currently displayed. The stop button 909 is a soft key for stopping the content obtaining processing that is being executed.

The status area 910 is an area for displaying messages from the functions of the image processing device. The status area 910 displays the message for promoting the user's notification from the scanner, printer, or another function, even upon displaying the web browser screen. Further, the status area 910 displays the message from the web browser function. The web browser function displays the URL character string as the link destination, title character string of the content, and the message instructed by the script.

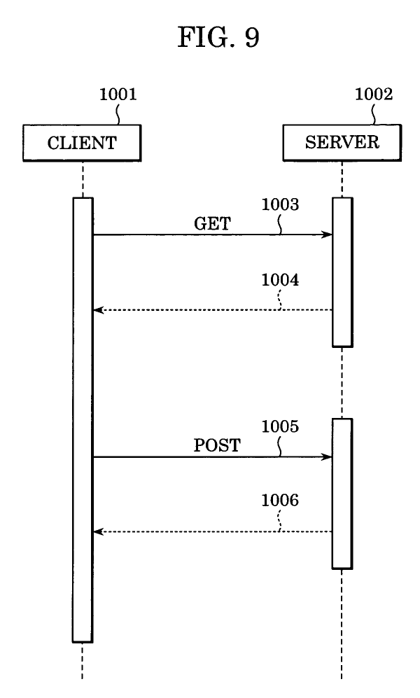

Next, a description is given of the operation according to the first embodiment with reference to FIG. 9. FIG. 9 is a sequence diagram showing the flow of the request and response processing using the HTTP protocol according to the first embodiment of the present invention.

Referring to FIG. 9, a client 1001 is software for sending the HTTP request and receiving the HTTP response, and is a general web browser that is operated on a PC (personal computer), a PDA (personal digital assistant) and a mobile phone, or various software for accessing the web server by the same method as that of the web browser and using and relaying the service. A server 1002 is software for receiving the HTTP request, performing the processing corresponding thereto, and returning the HTTP response, and is an HTTP server including the software that is operated on the server 155 according to the first embodiment.

The client 1001 sends the HTTP request by any of GET method and POST method. Here, when the client 1001 sends an HTTP request 1003 for the desired resource to the server 1002 by GET method, the resource is generally designated using URI (Uniform Resource Identifier) format (particularly, URL (Uniform Resource Locator) format). The server 1002 obtains or generates the data corresponding to the resource designated by the HTTP request 1003, and returns the data by an HTTP response 1004. Here, when the designated resource corresponds to a static file, the server 1002 reads the corresponding file from a file system of the server 155, and obtains the data. When the designated resource corresponds to the processing such as a CGI program or Servlet, the server 1002 executes the corresponding processing. Although the processing generates the response for the request, side effects are caused, including the execution of the business logic and the access of the back end to DBMS (database management system) which are necessary for accomplishing the predetermined service in this processing. The generated data as a processing result is returned. Upon designating the resource for displaying the commodity catalog of the image processing device, the software for e-commerce is executed. The software executes the processing for referring to, from the database, the records such as the latest price or inventory status of the sheet, toner, and parts and the processing for shaping the information to the HTML or XML format and generating catalog document data.

When the data obtained by the HTTP response 1004 can be displayed, the client 1001 displays the content thereof. When the obtained data is the HTML document, the acquisition and display of the new resource are repeated only by selecting the link information embedded as hypertext in the document displayed on the web browser.

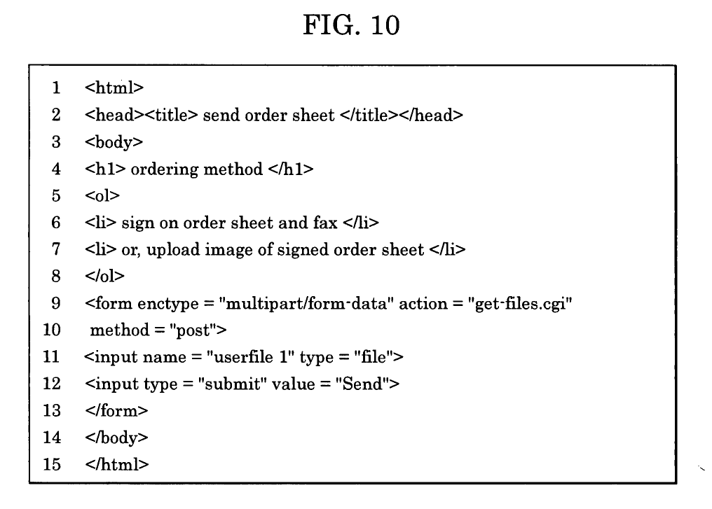

Next, the case of sending the HTTP request by the POST method will be described. When the HTML document includes the form and the sending method of the document designates the POST method (refer to the HTML document in FIG. 10), the information input by the user is encoded to the form displayed by the web browser of the client 1001, the encoded information, namely, the input content of the form is added to an HTTP request 1005, and is sent to the server 1002. In the server 1002, the designated resource receives the data sent from the client 1001, performs the processing, generates an HTTP response 1006, and returns the generated response to the client 1001.

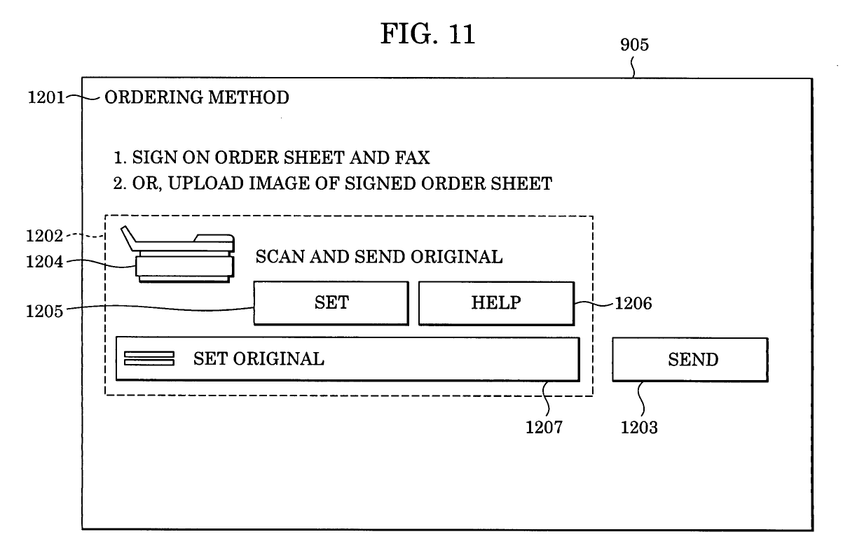

Next, a description is given of the structure of the HTML document that designates the POST method as the sending method and the screen displayed based on the HTML with reference to FIGS. 10 and 11. FIG. 10 is a diagram showing an example of the HTML document that includes the form and designates the POST method as the sending method. FIG. 11 is a diagram showing the screen displayed on the content display area 905 of the web browser based on the HTML document shown in FIG. 10.

In the example of the HTML document which includes the form and designates the POST method as the sending method, referring to FIG. 10, the tag indicating the start of the HTML element is shown on the first line. On the second line, a HEAD element and a TITLE element included therein are shown. On the third line, a tag indicating the start of a BODY element is shown. On the fourth line, an H1 element is shown. On the fifth line, a tag indicating the start of an OL element is shown. LI elements in the OL element are handled as a list having a rank order. On the sixth and seventh lines, the LI elements are shown. On the eighth line, a tag indicating the end of the OL element is shown. On the ninth and tenth lines, a tag indicating the start of a FROM element is shown. In this form, the input information is encoded in the multipart/form data type, and the property is shown by sending get-file.cgi resource by the POST method. The eleventh line indicates an INPUT element. According to the property, the first INPUT-element is named as userfile1 and shows the type of file. The twelfth line indicates the second INPUT-element. According to the property, the second INPUT-element has the type of submit and the value of a character string “Send”. The thirteenth line indicates the end of the FROM element. On the fourteenth line, a tag indicating the end of the BODY element is shown. On the fifteenth line, a tag indicating the end of the HTML element is shown.

Referring to FIG. 11, in the client 1001, the screen is displayed in the content display area 905 (refer to FIG. 8) based on the HTML document by the web browser. On the screen displayed based on the HTML document, the indication corresponding to the H1 element and OL element on the fourth to eighth lines in FIG. 10 is indication 1201, the indication corresponding to the INPUT element of the file type on the eleventh line in FIG. 10 is indication 1202 as a rectangular area, and the indication corresponding to the INPUT element of the submit type on the twelfth line in FIG. 10 is indication 1203.

In the indication 1202, unique indications 1204, 1205, 1206, and 1207 are shown, with the feature of the web browsers of the image processing devices 110, 120, and 130 according to the first embodiment. The indication 1204 shows an icon schematically showing an image input function and a message (“scan and send original”) which describes a function for uploading the image input. The indication 1205 shows a button for starting the operating setting of the image input function. The indication 1206 shows a button for starting the function description of the function for uploading the image input. The indication 1207 shows a message display area for displaying a message indicating the status of the image input function.

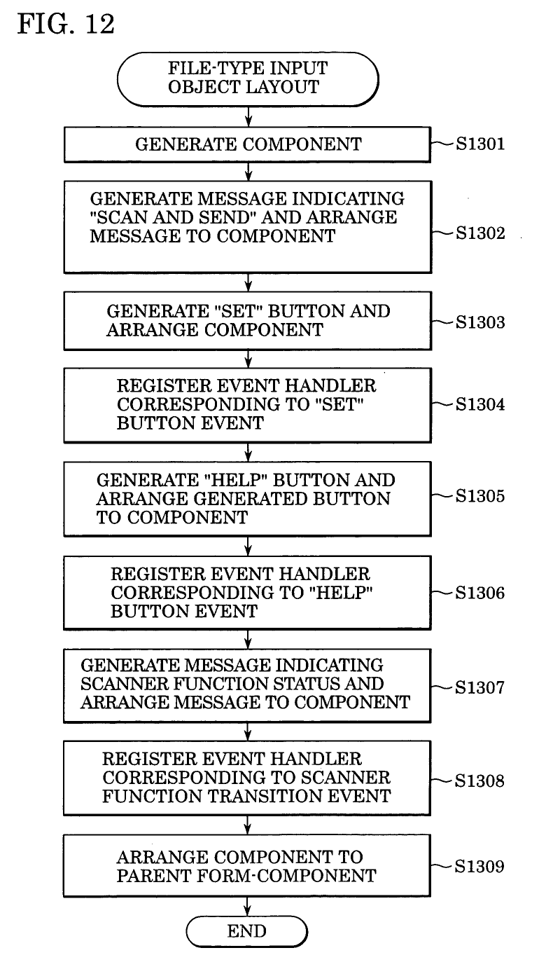

Next, a description is given of the layout processing of the object corresponding to the file-type INPUT element which is performed by the web browsers of the image processing devices 110, 120, and 130 with reference to FIG. 12. FIG. 12 is a flowchart showing the sequence of the layout processing of the object corresponding to the file-type INPUT element performed by the web browsers of the image processing devices 110, 120, and 130. Here, a description is given, assuming that the layout processing generates the layout corresponding to the indication 1202 on the screen in FIG. 11.

Referring to FIG. 12, in step S1301, the CPU 301 generates a component object as one unit of the layout processing. In step S1302, the CPU 301 generates the message “scan and send original” corresponding to the indication 1204, and arranges the generated message to the component. In step S1303, the CPU 301 generates a button corresponding to the indication 1205, namely, “set” button, and arranges the generated button to the component. In step S1304, the CPU 301 registers the operating setting processing of the image input function as an event handler which starts upon starting the event for pressing down the generated “set” button.

In step S1305, the CPU 301 generates a button corresponding to the indication 1206, namely, “help” button, and arranges the generated button to the component. In step S1306, the CPU 301 registers the function describing processing of the function for uploading the image input as the event handler which is started upon starting the event for pressing the “help” button.

In step S1307, the CPU 301 generates a message corresponding to the indication 1207 which transmits the status of the image input function, namely, “set original”, and arranges the generated message to the component. In step S1308, the CPU 301 registers the processing for updating the data to a message indicating the new status as the event handler which is started upon starting the status transition event of the image input function. In step S1309, the CPU 301 arranges the component to the component object corresponding to the BODY element as a parent component thereof. By the processing sequence, the tree structure is generated to express the inclusive relation of the component objects corresponding to the elements, and the screen display is laid out by reclusively processing the tree.

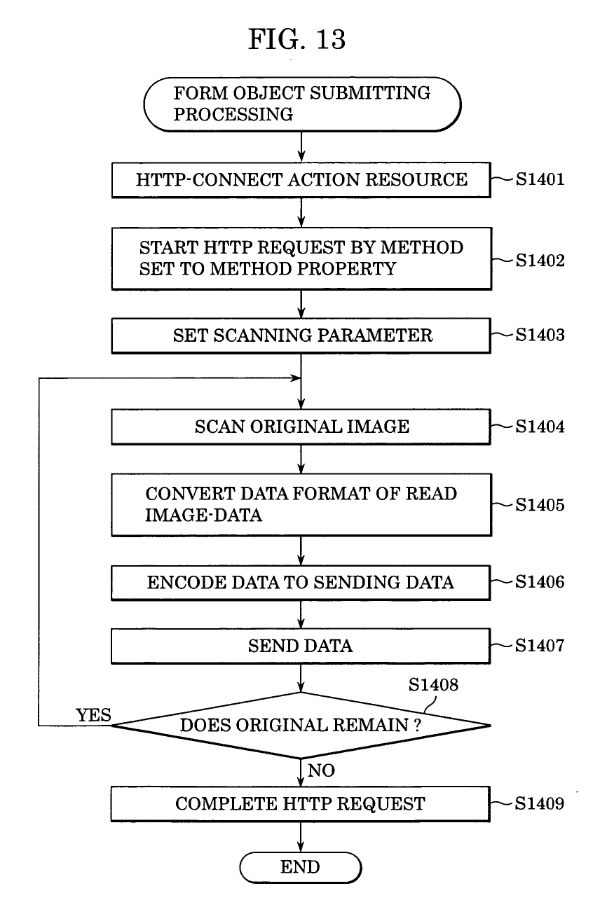

Next, a description is given of the submitting processing of the form performed by the web browsers of the image processing devices 110, 120, and 130 with reference to FIG. 13. FIG. 13 is a flowchart showing the sequence of the submitting processing of the form performed by the web browsers of the image processing devices 110, 120, and 130. The processing is executed for the FORM element including the INPUT element, upon generating the input event of the object corresponding to the submit-type INPUT element. That is, upon generating the event for pressing the “Send” button of the indication 1203 on the screen shown in FIG. 11. The implementation of the processing is distributed to a plurality of objects, the detail thereof is omitted, and it is described as a series of processing sequence.

Referring to FIG. 13, in step S1401, the CPU 301 performs the HTTP connection to the URI resource set to the action property of the object corresponding to the FORM element (in HTTP1.1, if the connection to the server has already been established, this step is omitted). In step S1402, the CPU 301 starts the HTTP request by the sending method set to a method property of the object corresponding to the FROM component. Here, the POST transmission is set as the sending method. In step S1403, the CPU 301 sets the control API 218 based on the operating setting of the image input function stored as the property of the object corresponding to the file-type INPUT component.

In step S1404, the CPU 301 calls the control API 218, and starts the scanning job. Thus, the reading of the original starts. In step S1405, the CPU 301 converts the read image data into data in the image format compatible with the transmission and in the data format (file format). In step S1406, the CPU 301 encodes the image data in the multipart/form-data set to enctype property of the FORM element.

In step S1407, the CPU 301 sends the encoded image data. In step S1408, the CPU 301 determines whether or not the read original remains. If it is determined that the read original remains (yes in step S1408), the CPU 301 returns to step S1404 and repeats the sequence from step S1404. On the other hand, if it is determined that the read original does not remain (no in step S1408), the CPU 301 completes the HTTP request (in step S1409) and ends the processing.

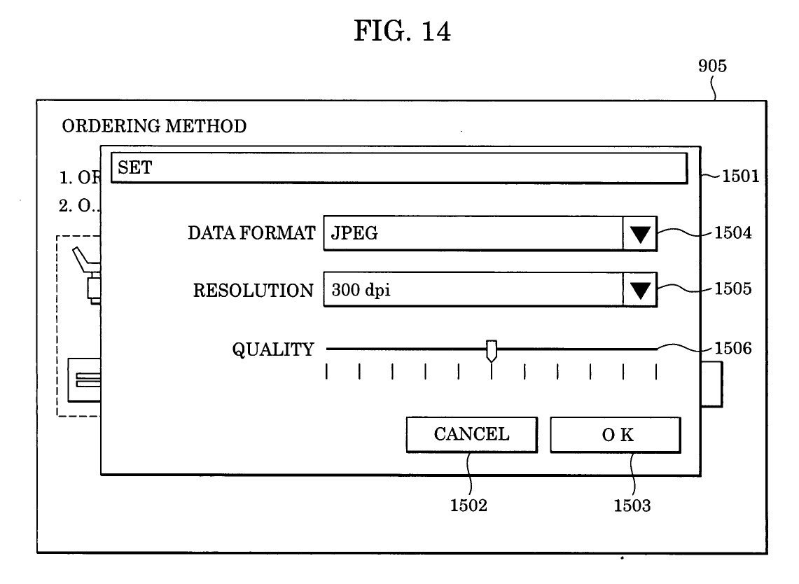

Next, a description is given of a dialog window displayed for the operation setting processing of the image input function by the web browser according to the first embodiment with reference to FIG. 14. FIG. 14 is a diagram showing an example of the dialog window displayed for the operating setting processing of the image input function by the web browser.

The button in the indication 1205 in FIG. 11, namely, “set” button is pressed down and then a dialog window 1501 is displayed on the content display area 905 of the web browser. The dialog window 1501 includes a Cancel button 1502, an OK button 1503, a data format selecting list box 1504, a resolution selecting list box 1505, and a quality slider 1506.

The Cancel button 1502 cancels the setting and closes the dialog. The OK button 1503 determines the setting and closes the dialog. The data format selecting list box 1504 is a box for selecting the used data format such as the encoding format, compressing format, and file format so as to read the original and express the image data. The resolution selecting list box 1505 is a box for designating the resolution upon reading the original image. The quality slider 1506 is a slider for designating the desired image quality. A parameter, such as a compressing rate of the data which is finally generated, is determined in response to the instruction of the quality slider 1506.

When the server sets accept property to the file-type INPUT element in the form, the web browser selects only the data format compatible with the medium type or type pattern included in the accept property as a selecting candidate of the dialog window 1501. The sending data format of a default is determined based on the combination of the medium type designated to the accept property and the data format which can be sent by the image processing device, and the determined sending data format is used for the operating setting of the image input function.

As described above, the submission process of the form executed by the web-browser in FIG. 13 is executed as to the FORM factor including the INPUT factor when an input event of an object corresponding to an INPUT factor as a submit type is initiated, in other words, when an event corresponding to pushing the button “Send” of the display 1203 shown in FIG. 11 is initiated. It may be arranged so as to generate an event similar to the event of the push of the “Send” button 1203 based on the physical push of the start key 505 and to execute the submission process of the form. It may be arranged so as to distinguish an enable status (or a disable status) indicating whether the “Send” button 1203 can be pushed (e.g. crosshatching display of the button 1203 in the disable status). It may be arranged so as to control the color of the LED in the two-color LED display 506 built-in the start key 505 based on the determination of the status of whether the scan job can be started (the status can be obtained on calling the control API 218).

According to the first embodiment, it is possible to upload, to the server, the data in the sheet original (including the document or public document that requires the signature and seal) individually-sent via the fax in the conventional order via the web. That is, the working flow on the web includes an input step of the sheet original. The data in the sheet original is obtained by describing only the general web page that needs the file uploading operation on the ASP side.

Further, it is possible to provide a system in which the working flow on the web includes the processing based on the image data that is obtained by requesting, on the ASP side, and the processing of the operation for obtaining the image by the web page having the form that requires the general file-uploading operation. In particular, it is possible to provide an image processing device including the web browser, in which the user performs, at one time, both the image input operation and the uploading operation of the image data in accordance with the request from the ASP in the simple operating sequence.

Furthermore, the operating sequence is simplified by displaying the messages indicating the start of the setting of the image input operation and the uploading operation, the start of user help, and the operating status together with the display operation of the file uploading request (namely, image input request).

In addition, it is possible to provide the image processing device that does not require the storage capacity by simultaneously performing both the image input operation and the uploading operation.

### Second Embodiment

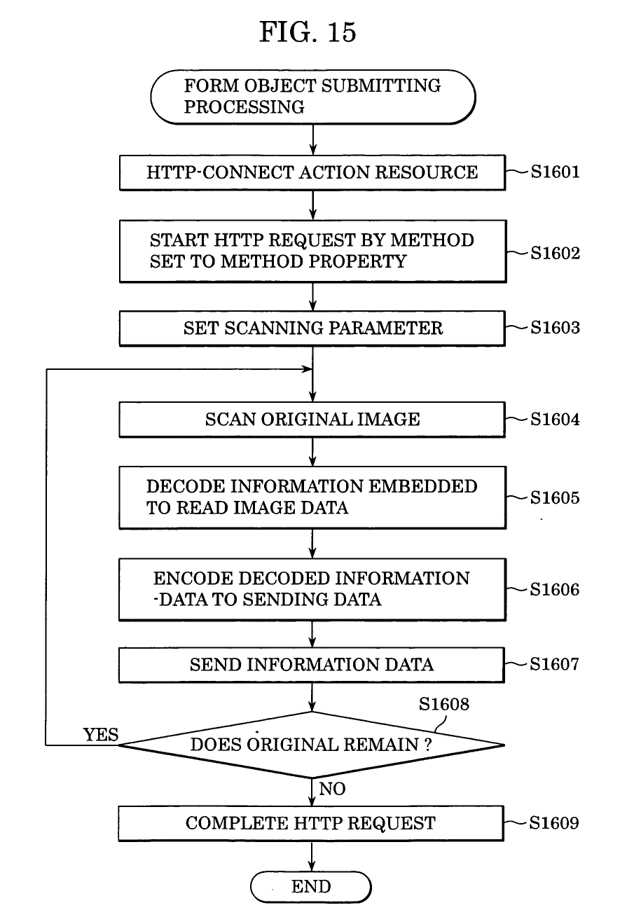

Next, a description is given of the second embodiment of the present invention with reference to FIG. 15. FIG. 15 is a flowchart showing the sequence of the submitting processing of the form which is executed by the web browser according to the second embodiment of the present invention. The second embodiment has the same structure as that according to the first embodiment and therefore a description is not repeated here.

According to the second embodiment, similarly to the first embodiment, upon generating the input event of the object corresponding to the submitting-type INPUT element, that is, upon generating the event for pressing the button of the indication 1203 on the screen in FIG. 11, the processing in the sequence shown in FIG. 15 is executed for the FORM element including the INPUT element. Although the implementation of processing is actually distributed to a plurality of objects, the details thereof are not described here and a series of processing is described.

Referring to FIG. 15, in step S1601, the CPU 301 connects by HTTP the resource of the URL set to the action property of the object corresponding to the FORM element (in the case of HTTP 1.1, step S1601 is omitted if the connection to the server has already been established). In step S1602, the CPU 301 starts the HTTP request by the method (here, POST sending method) set to the method property of the object corresponding to the FORM element. In step S1603, the CPU 301 sets the control API 218 based on the operation setting of the image input function which is stored as the property of the object corresponding to the file-type INPUT element. In step S1604, the CPU 301 calls the control API 218, and starts the scanning job. Thus, the original is read.

In step S1605, the CPU 301 decodes the information embedded in the read image data by using the information-embedded image codec module 229. The information-embedded image is decoded by technology such as a barcode, digital watermark, or OCR (optical character recognition). The decoded information is encoded as various types of data such as text data, number, sound, image (image embedded as the information data in the original image), or application-specific data. In step S1606, the CPU 301 encodes the information data in the multipart/form data format which is set to the enctype property of FORM element.

In step S1607, the CPU 301 sends the encoded information data. In step S1608, the CPU 301 determines whether or not the read original remains. If it is determined that the read original remains (yes in step S1608), the CPU 301 returns to step S1604 and repeats the sequence from step S1604. If it is determined that the read original does not remain (no in step S1608), the CPU 301 completes the HTTP request (in step S1609) and processing ends.

When the server sets, to the accept property, the file-type INPUT element in the FORM element, in step S1605, the type of decoded information data is that which is compatible with the medium type or type pattern according to the accept property. Upon setting the text type to the accept property, the CPU 301 performs the OCR processing of the original image data, and sends the information data in the obtained text type.

According to the second embodiment, in addition to the advantages according to the first embodiment, it is possible to provide a system with a simple operating sequence, in which the working flow on the web includes the processing based on the information-embedded image for simultaneously combining the image input step, the decoding step of the information embedded in the input image data, and the uploading step of the decoded information.

A storage medium (or recording medium) may be supplied, to the system or apparatus. The storage medium (or recording medium) has stored thereon program code of software for realizing functions of the embodiment. A CPU or MPU (micro-processing unit) of the system or apparatus can read and execute the program code stored in the storage medium. In this case, the program code read from the storage medium realizes the functions according to the embodiment. An operating system (OS) working on the computer executes a part or the entire actual processing based on instructions of the program code in order to realizing the functions according to the embodiments.

Further, the program code read from the storage medium can be written to a memory of a function expansion card inserted in the computer or a function expansion unit connected to the computer. After that, a CPU of the function expansion card or function expansion unit executes a part or the entire actual processing based on the instruction of the program code in order to realize the functions according to the embodiments. When the present invention is applied to the storage medium, the storage medium stores therein the program code in accordance with the above-described flowcharts.

The present invention is not limited to the first and second embodiment, and can be modified without departing from the spirit of the present invention. The system according to the present invention may include an image processing device including the web browser, such as a digital camera, a mobile phone with a camera, and a flatbed scanner. Alternatively, the system may be formed by combining a single-function scanner and a computer. In this case, the web browser operated on the computer includes a specific interface for operating the scanner. In any case, the generality on the web server is maintained.

While the present invention has been described with reference to exemplary embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

This application claims priority from Japanese Patent Application No. 2003-388412 filed Nov. 18, 2003, which is hereby incorporated by reference herein.

1. An image processing device communicable with a server on a network, the image processing device comprising:
an image input unit configured to input image information;
a receiving unit configured to receive form information for sending data in accordance with the image information to an information resource on the server;
a sending unit configured to send data to the server;
a display unit configured to display a display screen for starting data transmission to the information resource by the sending unit based on the form information; and
a control unit configured to start input of the image information to the image input unit and to start transmission of data corresponding to the image information to the sending unit in accordance with an operation of the display screen.

2. An image processing device according to claim 1, wherein the control unit controls the sending unit so that the sending unit sends data corresponding to the image information to the server in a predetermined form based on the form information.

3. An image processing device according to claim 2, further comprising:
a converting unit configured to convert the image information input by the image input unit into data in the predetermined form,
wherein the sending unit sends the data in the predetermined form to the server.

4. An image processing device according to claim 3, wherein the converting unit converts the image information input by the image input unit into data in a predetermined encoding form based on the form information.

5. An image processing device according to claim 2, wherein the form information is information based on a hypertext markup language document,
the receiving unit receives, from the server, the form information based on the hypertext markup language document using a hypertext transfer protocol, and
instructing information indicating that data in the predetermined form is to be sent to the information resource included in the form information is information indicating a file-type input element in the hypertext markup language document.

6. An image processing device according to claim 5, wherein the display unit displays a display portion for starting data transmission to the information resource by the sending unit when the form information based on the hypertext markup language document includes information indicating a submit-type input element.

7. An image processing device according to claim 1, further comprising:
a setting unit configured to set an operating condition of the image input unit,
wherein the display unit displays a first display screen for starting data transmission to the information resource and a second display screen for setting an operating condition of the image input unit when the form information includes instructing information for sending data to the information resource,
the setting unit sets the operating condition of the image input unit in accordance with an operation of the second display screen, and
the control unit controls an operation so that the image input unit starts to input the image information based on the operating condition set by the setting unit in accordance with an operation of the first display screen.

8. An image processing device according to claim 7, wherein the display unit displays a third display screen for sending a notification indicating the operating condition of the image input unit together with the first and second display screens when the form information includes instructing information for sending data to the information resource.

9. An image processing device according to claim 7, wherein the image input unit inputs the image information by reading an original, and
the operating condition of the image input unit is at least one of a data form of the image information, resolution for reading the original, and compression of image data.

10. An image processing device according to claim 1, further comprising:
a decoding unit configured to decode information embedded to the image information input by the image input unit,
wherein the sending unit sends, to the server, data corresponding to the information decoded by the decoding unit as the data corresponding to the image information.

11. An image processing device according to claim 10, further comprising:
a converting unit configured to convert the information decoded by the decoding unit into data in a predetermined form,
wherein the sending unit sends the data in the predetermined form to the server.

12. An image processing device according to claim 11, wherein the converting unit converts the image information input by the image input unit into data in a predetermined encoding form based on the form information.

13. An image processing device according to claim 1, wherein the image input unit inputs the image information by reading an original.

14. An image processing device according to claim 1, wherein the form information is information based on a hypertext markup language document, and
the receiving unit receives, from the server, the information based on the hypertext markup language document using a hypertext transfer protocol.

15. An image processing device according to claim 1, further comprising:
an identification information input unit configured to input identification information for identifying the information resource on the server.

16. A control method of an image processing device communicable with a server on a network, the control method comprising;
receiving, from the server, form information for sending data in accordance with image information to an information resource on the server;
displaying a display screen for starting data transmission to the information resource based on the form information;
starting input of the image information in accordance with an operation of the display screen; and
starting transmission of data corresponding to the image information, to the server, in accordance with an operation of the display screen.

17. A control method of an image processing device according to claim 16, wherein data corresponding to the image information is sent to the server in a predetermined form based on the form information.

18. A control method of an image processing device according to claim 17, further comprising:
converting the image information input into data in the predetermined form,
wherein the data in the predetermined form is sent to the server.

19. A control method of an image processing device according to claim 18, wherein the image information is converted into data in a predetermined encoding form based on the form information.

20. A control method of an image processing device according to claim 17, wherein the form information is information based on a hypertext markup language document,
the information based on the hypertext markup language document is received from the server via a hypertext transfer protocol, and
instructing information indicating that data in the predetermined form is to be sent to the information resource included in the form information is information indicating a file-type input element in the hypertext markup language document.

21. A control method of an image processing device according to claim 20, wherein a display portion is displayed for starting data transmission to the information resource when the form information based on the hypertext markup language document includes information indicating a submit-type input element.

22. A control method of an image processing device according to claim 16, further comprising:
setting an operating condition of the image information,
wherein a first display screen is displayed for starting data transmission to the information resource and a second display screen is displayed for setting the operating condition of the image information when the form information includes instructing information for sending the data to the information resource,
the operating condition of the image information is set in accordance with an operation of the second display screen, and
an operation is controlled so that starting input of the image information is based on the operating condition of the image information set in accordance with an operation of the first display screen.

23. A control method of an image processing device according to claim 22, wherein a third display screen is displayed for sending a notification indicating the operating condition of the image information together with the first and second display screens when the form information includes instructing information for sending the data to the information resource.

24. A control method of an image processing device according to claim 22, wherein the image information is input by reading an original, and
the operating condition of the image information is at least one of a data form of the image information, resolution for reading the original, and compression of image data.

25. A control method of an image processing device according to claim 16, further comprising:
decoding information embedded with the image information,
wherein data on the information decoded is sent to the server as the data corresponding to the image information.

26. A control method of an image processing device according to claim 25, further comprising:
converting the information decoded into data in a predetermined form,
wherein the data in the predetermined form is sent to the server.

27. A control method of an image processing device according to claim 26, wherein the image information input is converted into data in a predetermined encoding form based on the form information.

28. A control method of an image processing device according to claim 16, wherein the image information is input by reading an original.

29. A control method of an image processing device according to claim 16, wherein the form information is information based on a hypertext markup language document, and
information based on the hypertext markup language document is received from the server using a hypertext transfer protocol.

30. A control method of an image processing device according to claim 16, further comprising:
inputting identification information for identifying the information resource on the server.
